(19) United States
(12) Patent Application Publication
(10) Pub. No.: US 2009/0070358 A1
(43) Pub. Date: Mar. 12, 2009

(54) APPARATUS, METHOD, AND COMPUTER PROGRAM PRODUCT FOR PROCESSING INFORMATION

(75) Inventors: Seiji Tokura, Kanagawa (JP); Miwako Doi, Kanagawa (JP); Fumio Ozaki, Kanagawa (JP); Hisashi Hayashi, Kanagawa (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/203,385

(22) Filed: Sep. 3, 2008

(30) Foreign Application Priority Data
Sep. 5, 2007 (JP) 2007-229989

(51) Int. Cl. G06F 17/30

(52) U.S. Cl. 707/101; 707/E17.009

(57) ABSTRACT

An information processing apparatus includes a plurality of information reforming modules that reform input information input from each information device to common format information, which is a format common to the respective information devices, and a status-information storage unit that stores status information indicating a status for each of predetermined items of the reformed common format information, for each of the information reforming modules. The apparatus specifies the information reforming module that satisfies a use request condition, from one or a combination of a plurality of pieces of status information stored in the status-information storage unit, acquires the common format information reformed by the specified information reforming module, processes the acquired common format information to use information matched with the use request condition, and outputs the processed use information.

### CROSS-REFERENCE TO RELATED APPLICATIONS

This application is based upon and claims the benefit of priority from the prior Japanese Patent Application No. 2007-229989, filed on Sep. 5, 2007; the entire contents of which are incorporated herein by reference.

### BACKGROUND OF THE INVENTION

1. Field of the Invention

The present invention relates to an apparatus, a method, and a computer program product for processing information.

2. Description of the Related Art

Recently, progress in science and technology has made it possible to provide highly accurate sensors at a low price. Accordingly, techniques for obtaining information of external environment by using a sensor and using the information have been proposed.

As utilization of the technique for obtaining the information of the external environment, it has been considered to apply the technique to a ubiquitous home for providing an environment suitable for a user. To do this, various sensors need to be equipped. However, programs need to be installed for each of various sensors, and therefore load of development and maintenance increases.

In a technique described in “A Survey of Middlewares in Wireless Sensor Network and Support by Agent Technology”, JAWS2006, by Kenji TEI and two others, disparity between sensor nodes using different hardware is absorbed, to provide a common interface with respect to applications. Accordingly, each application can obtain data without being conscious of the type and internal operations of the sensor.

However, in the technique described in the above reference, the effect thereof is limited to the use without being conscious of the type, and processing of the information input from the sensor according to a request is not mentioned.

For example, if an information using unit tries to obtain and use position information in triaxial directions, when there are a sensor that detects X- and Y-axial directions and a sensor that detects a Z-axial direction, pieces of information of these sensors need to be processed on the information using unit side, thereby causing a problem in that a development load on the information using unit is large.

### SUMMARY OF THE INVENTION

According to one aspect of the present invention, an information processing apparatus includes a plurality of information reforming modules that reform input information input from each information device to common format information, which is a format common to the respective information devices; a status-information storage unit that stores status information indicating a status for each of predetermined items of the common format information reformed by the information reforming modules, for each of the information reforming modules; an input receiving unit that receives an input of a use request condition including a condition for each of the predetermined items; a specifying unit that specifies the information reforming module that satisfies the use request condition, from one or a combination of a plurality of pieces of status information stored in the status-information storage unit; an acquiring unit that acquires the common format information reformed by the specified information reforming module; a processing unit that processes the acquired common format information to use information matched with the use request condition; and an output unit that outputs the processed use information.

According to another aspect of the present invention, an information processing method includes reforming input information input from each information device to common format information, which is a format common to the respective information devices, by an information reforming module; storing status information indicating a status for each of predetermined items of the reformed common format information for each of the information reforming modules, in a status-information storage unit; receiving an input of a use request condition including a condition for each of the predetermined items; specifying the information reforming module that satisfies the use request condition, from one or a combination of a plurality of pieces of status information stored in the status-information storage unit; acquiring the common format information reformed by the specified information reforming module; processing the acquired common format information to use information matched with the use request condition; and outputting the processed use information.

A computer program product according to still another aspect of the present invention causes a computer to perform the method according to the present invention.

### BRIEF DESCRIPTION OF THE DRAWINGS

FIG. 1 is a schematic diagram for explaining a concept using a mobile robot having an information processing apparatus according to an embodiment;

FIG. 2 is a block diagram of a functional configuration of the information processing apparatus according to the embodiment;

FIG. 3 is a block diagram of a functional configuration of a first adjacent-object-position measurement module;

FIG. 4 is a drawing illustrating an example of an API provided by each module;

FIG. 5 is a drawing illustrating an example of determination criteria of whether each module is available;

FIG. 6 is a drawing illustrating an example of information presented by a characteristic presentation unit;

FIG. 7 is a drawing illustrating an example of common format information abstracted by an editing and abstracting unit;

FIG. 8 is a drawing illustrating an example of a table structure of a status storage unit;

FIG. 9 is a drawing illustrating an example of a table structure of a request-condition storage unit;

FIG. 10 is a drawing illustrating an example of a table structure of an integration-criteria-information storage unit;

FIG. 11 is a drawing illustrating an example of an API provided by a solver unit;

FIG. 12 is a flowchart of a process procedure when a module is added to the information processing apparatus;

FIG. 13 is a flowchart of a process procedure when a module is deleted from the information processing apparatus;

FIG. 14 is a flowchart of a process procedure when an information using unit requests provision of information;

FIG. 15A is a flowchart of a first process procedure for specifying a module to be used to provide information to the information using unit;

FIG. 15B is a flowchart of a second process procedure for specifying a module to be used to provide information to the information using unit;

FIG. 16 is a flowchart of a process procedure from acquisition of information in the solver unit to output of the information to the information using unit;

FIG. 17 is a timing chart of a process procedure for controlling an information output apparatus when a request for information is received from the information using unit;

FIG. 18 is a timing chart of a process procedure for the information using unit to acquire data when an information access mode is an asynchronous operation;

FIG. 19A is a timing chart of a first process procedure to be performed when there is a characteristic or status change in the information device;

FIG. 19B is a timing chart of a second process procedure to be performed when there is a characteristic or status change in the information device; and

FIG. 20 depicts a hardware configuration of the information processing apparatus.

### DETAILED DESCRIPTION OF THE INVENTION

Exemplary embodiments of an apparatus, a method, and a computer program product for processing information according to the present invention will be explained below in detail with reference to the accompanying drawings. In the following embodiment, an example of a mobile robot having the information processing apparatus incorporated therein is explained. However, the information processing apparatus is applicable not only to the mobile robot but also to various apparatuses such as a personal computer (PC) and a server.

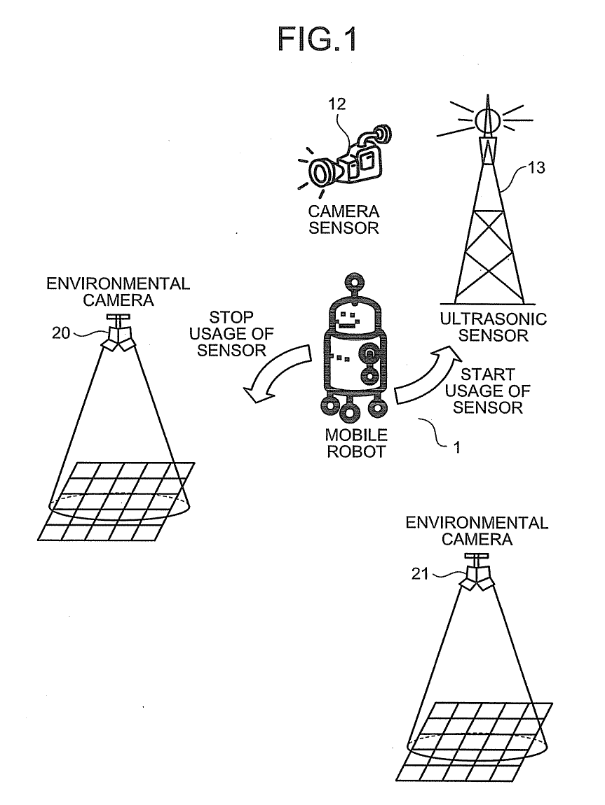

As shown in FIG. 1, a mobile robot 1 according to an embodiment can use information input from various sensors according to a destination. For example, when the mobile robot 1 moves to an area in which an ultrasonic sensor 13 and a camera sensor 12 are provided, the mobile robot 1 starts to use the ultrasonic sensor 13 and the camera sensor 12, to specify the position of the mobile robot 1. When the mobile robot 1 moves out from the area provided with the ultrasonic sensor 13 and the camera sensor 12 to an area provided with an environmental camera 20, the mobile robot 1 stops usage of the ultrasonic sensor 13 and the camera sensor 12 and starts to use the environmental camera 20. Further, as for an environmental camera 21, when the mobile robot 1 moves to an area in which the environmental camera 21 is available, the mobile robot 1 starts to use it. The information processing apparatus incorporated in the mobile robot 1, which enables such usage, is explained next.

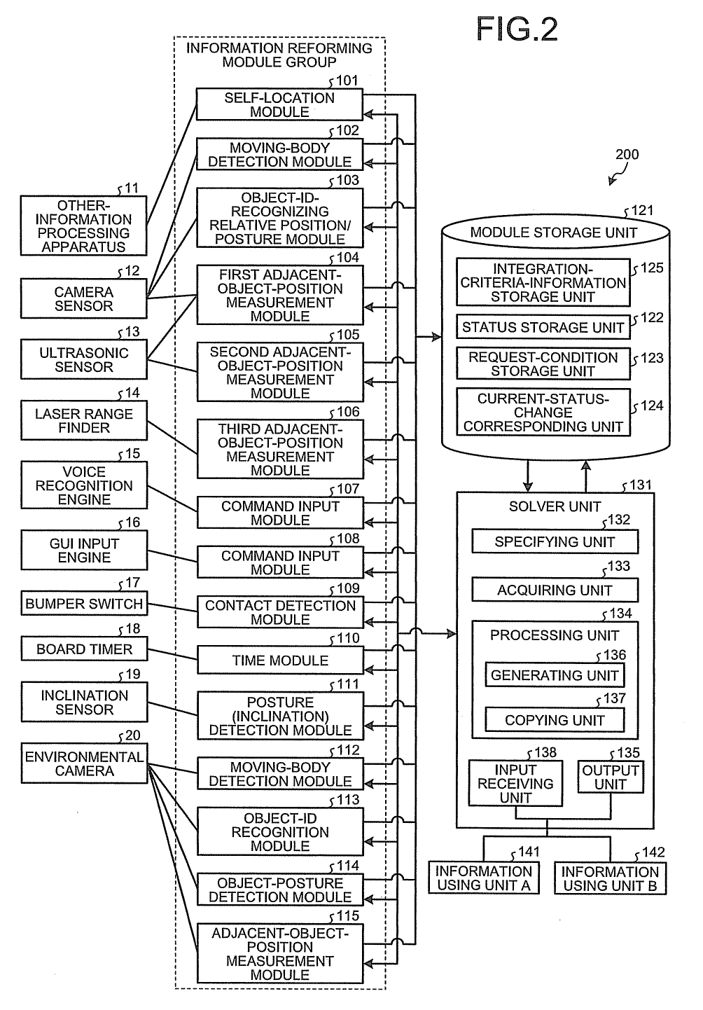

As shown in FIG. 2, an information processing apparatus 200 includes the camera sensor 12, the ultrasonic sensor 13, a laser range finder 14, a voice recognition engine 15, a graphical user interface (GUI) input engine 16, a bumper switch 17, a board timer 18, an inclination sensor 19, the environmental camera 20, an information reforming module group (information conversion module group), a module storage unit (status-information storage unit) 121, a solver unit 131, an information using unit A 141, and an information using unit B 142. The information processing apparatus 200 is connected to another information processing apparatus 11 wirelessly or with wire, to enable communication with the other-information processing apparatus 11.

The other-information processing apparatus 11, the camera sensor 12, the ultrasonic sensor 13, the laser range finder 14, the voice recognition engine 15, the GUI input engine 16, the bumper switch 17, the board timer 18, the inclination sensor 19, and the environmental camera 20 function as an information device, and output information to the module connected thereto. The information input from the information device is referred to as input information here.

The information using units A 141 and B 142 request acquisition of information to the solver unit 131, when processing is to be performed by using information of an external environment. The information provided from the solver unit 131 to the information using units A 141 and B 142 is referred to as use information here. The information using units A 141 and B 142 present a condition for accepting provision of the use information with respect to the solver unit 131. This condition is referred to as a use request condition.

The information reforming module group includes a self-location module 101, a moving-body detection module 102, an object-ID-recognizing relative position/posture module 103, a first adjacent-object-position measurement module 104, a second adjacent-object-position measurement module 105, a third adjacent-object-position measurement module 106, a command input module 107, a command input module 108, a contact detection module 109, a time module 110, a posture (inclination) detection module 111, a moving-body detection module 112, an object-ID recognition module 113, an object-posture detection module 114, and an adjacent-object-position measurement module 115.

Each module controls each information device (sensor device and recognition engine) connected thereto, abstracts the information input from the information device in a format common to information devices, and outputs the information to the solver unit 131 as common format information reformed to a requested provision format. The first adjacent-object-position measurement module 104 is explained next as an example of the information reforming module. Other information reforming modules have the same configuration as that of the first adjacent-object-position measurement module 104, and explanation thereof will be omitted. Further, each module also presents a characteristic of the common format information, which can be provided, with respect to the solver unit 131.

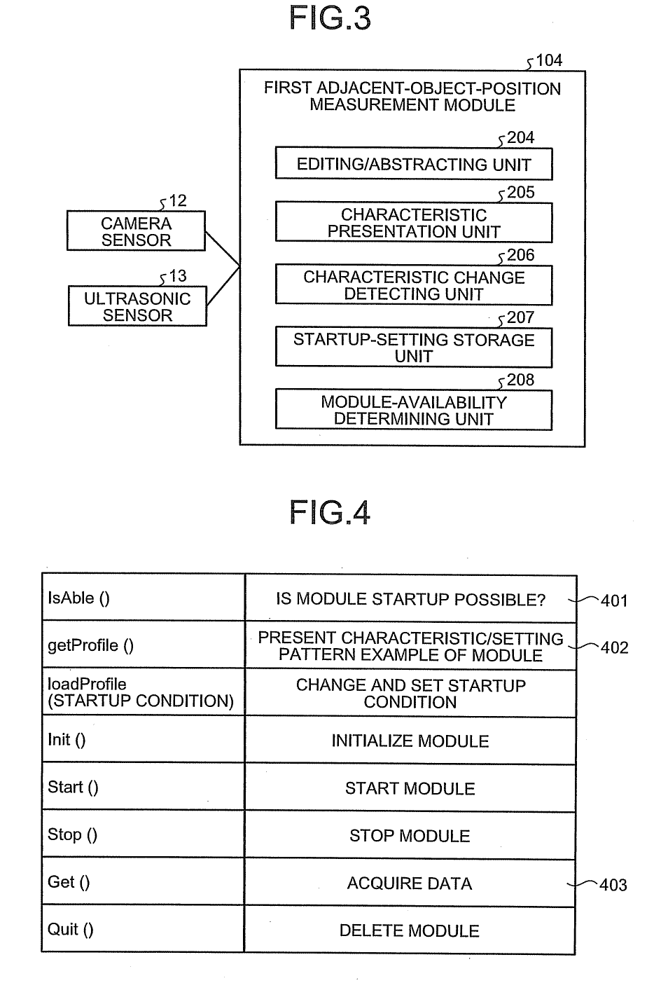

As shown in FIG. 3, the first adjacent-object-position measurement module 104 is connected to the camera sensor 12 and the ultrasonic sensor 13, and performs input processing of information detected by these sensors. The first adjacent-object-position measurement module 104 includes an editing/abstracting unit 204, a characteristic presentation unit 205, a characteristic change detecting unit 206, a startup-setting storage unit 207, and a module-availability determining unit 208. The first adjacent-object-position measurement module 104 performs input processing of signals from the camera sensor 12 and the ultrasonic sensor 13, reforms the signals to a common predetermined provision format, regardless of the sensor, and outputs the reformed signals to the solver unit 131.

As shown in FIG. 4, not only the first adjacent-object-position measurement module 104 but also each module provide an API (Application Programming Interface) for accepting an operation from the solver unit 131 and the module storage unit 121. The module can be used by invoking the API.

For example, it can be confirmed whether startup of the module is possible by invoking IsAble( ) shown by reference symbol 401. Further, by invoking getProfile( ) shown by reference symbol 402, a characteristic/setting pattern example of the module can be presented from the module. By invoking Get( ) shown by reference symbol 403, information according to a provision format provided by the module can be acquired. Further, a startup condition changing or setting function, a module initialization function, a module startup function, a module stop function, a module termination function, and the like can be used by other APIs.

The module-availability determining unit 208 determines whether the first adjacent-object-position measurement module 104 can be used according to availability determination criteria, when being invoked by IsAble( ) from the solver unit. When the solver unit 131 invokes the IsAble( ), the use request condition for each item is stored as a parameter.

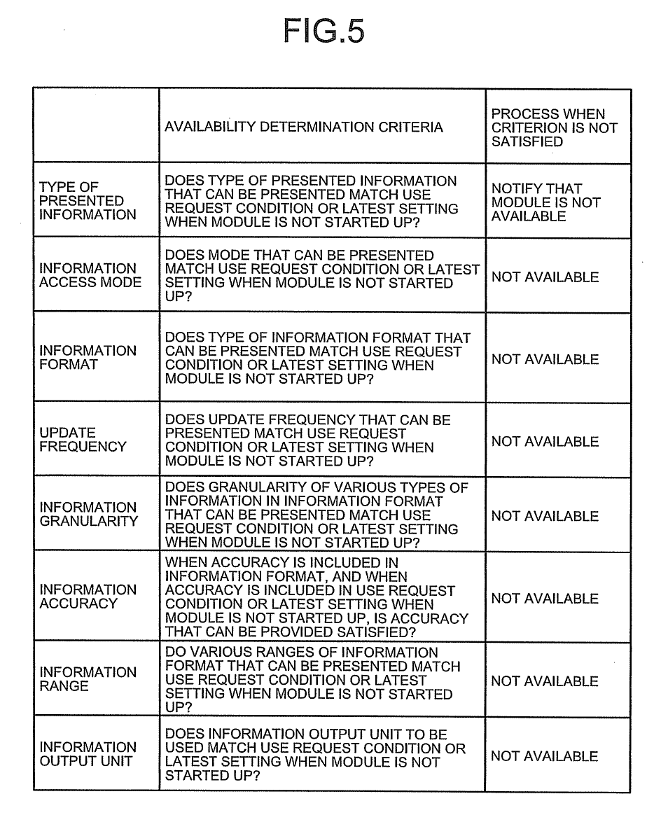

As shown in FIG. 5, the availability determination criterion is provided for each item of type of presented information, information access mode, information format, update frequency, information fineness, information accuracy, information range, and information device.

The presented information type indicates the type of information to be provided, and includes, for example, an adjacent object position. The information access mode indicates a method at the time of outputting the information. As an example, synchronous communication can be mentioned, which is performed according to information request timing from the information using unit to the solver unit 131. There is also asynchronous communication for acquiring information and performing processing at timing different from the information request timing from the information using unit to the solver unit 131.

The information format indicates an element included in the presented information, and for example, relative-coordinate depth direction, relative-coordinate lateral direction, relative-coordinate height, posture roll, posture pitch, and posture yaw can be included.

The update frequency indicates an update frequency of the information provided, and for example, the update frequency is 15 fps. The information fineness indicates fineness of each element indicated in the information format, and for example, fineness of relative-coordinate depth direction, fineness of relative-coordinate lateral direction, fineness of relative-coordinate height, fineness of posture roll, fineness of posture pitch, and fineness of posture yaw can be included.

The information accuracy indicates accuracy of each element indicated in the information format, and for example, accuracy of relative-coordinate depth direction, accuracy of relative-coordinate lateral direction, accuracy of relative-coordinate height, accuracy of posture roll, accuracy of posture pitch, and accuracy of posture yaw can be included. The information range indicates a range measurable by each element indicated in the information format, and for example, there are a range of relative-coordinate depth direction, a range of relative-coordinate lateral direction, a range of relative-coordinate height, a range of posture roll, a range of posture pitch, and a range of posture yaw. Further, the information device indicates an information device such as a sensor connected to the module, and for example, a camera and an ultrasonic sensor can be mentioned.

The module-availability determining unit 208 determines whether the use request condition requested by the solver unit 131 is satisfied for each item. As shown in FIG. 5, the module-availability determining unit 208 determines that the module is not available if the condition is not satisfied in any one of these items.

When a characteristic change of the information device is detected by the characteristic change detecting unit 206, the module-availability determining unit 208 determines whether the module can be used continuously.

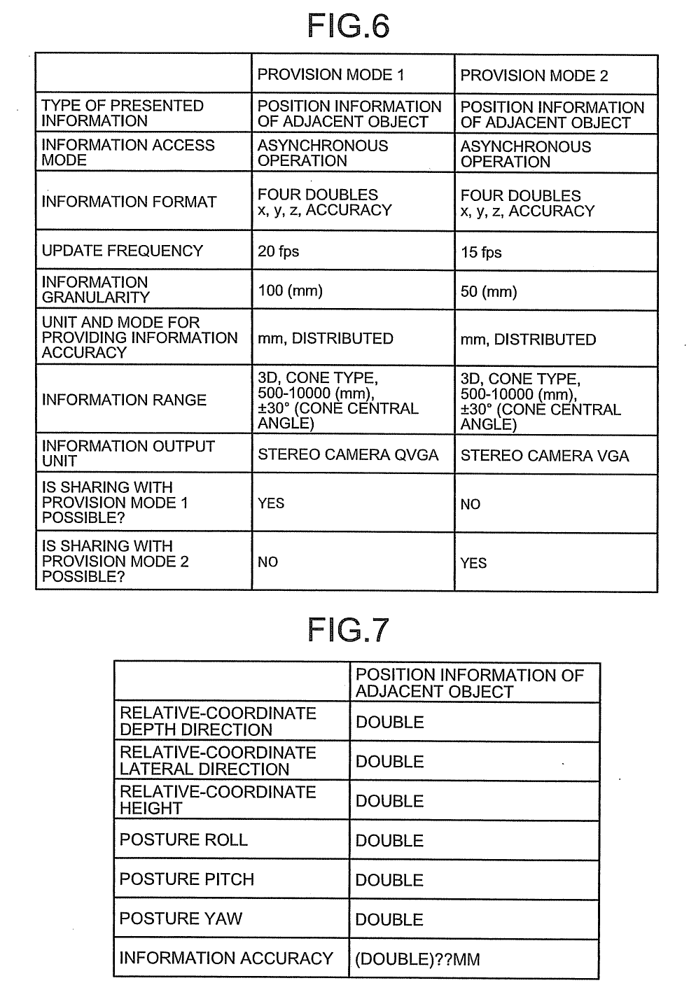

The characteristic presentation unit 205 presents a pattern of information to be output from the module to an invoker, when getProfile( ) is invoked. As shown in FIG. 6, the characteristic presentation unit 205 presents provision format 1 (provision mode 1) and provision format 2 (provision mode 2) to the invoker as patterns of information that can be presented by the module.

The startup-setting storage unit 207 stores a-startup condition of each sensor for providing the information in provision format 1 and provision format 2 shown in FIG. 6. Common format information can be provided in the provision format described above by controlling each sensor with the startup condition. Further, the startup-setting storage unit 207 stores the startup condition for providing the common format information in provision format 1 and provision format 2.

The editing/abstracting unit 204 edits and abstracts the input information input from either the camera sensor 12 or the ultrasonic sensor to the common format information in the above provision format. The common format information is information obtained by reforming the information input from the information device to a format that can be provided.

When Get( ) of the first adjacent-object-position measurement module 104 is invoked, as shown in FIG. 7, the first adjacent-object-position measurement module 104 outputs the common format information edited and abstracted by the editing/abstracting unit 204 to the invoker.

The characteristic change detecting unit 206 detects a characteristic change of the camera sensor 12 and the ultrasonic sensor 13. For example, if the accuracy decreases when direct sunlight is incident to these sensors, the characteristic change detecting unit 206 detects incidence of direct sunlight. The characteristic change detecting unit 206 also detects a fault of each information device.

Further, the characteristic change detecting unit 206 detects a change in the update frequency and accuracy of the common format information that can be provided by the first adjacent-object-position measurement module 104, and a change of characteristic setting of the common format information that can be presented. The characteristic change detecting unit 206 also detects a change in status due to a change of computer load in the module, a change of operating status, and a change of network load.

When having detected the change, the characteristic change detecting unit 206 notifies the module-availability determining unit 208 of this fact. Upon reception of the notification, the module-availability determining unit 208 calculates a characteristic change of the module due to the change, and compares a calculation result with the startup condition stored in the startup-setting storage unit 207. Thereafter, the module-availability determining unit 208 determines whether the information can be provided according to whether the startup condition is satisfied.

The module-availability determining unit 208 outputs a notification indicating whether the information can be provided continuously to the module storage unit 121 together with the changed characteristic. This notification indicating whether the information can be provided is designated as an information-provision disabling signal and an information-provision enabling signal. Accordingly, it is reflected on the module storage unit 121 whether the information can be provided, with an environmental change and a characteristic change of the information device.

Returning to FIG. 2, the module storage unit 121 includes an integration-criteria-information storage unit 125, a status storage unit 122, a request-condition storage unit 123, and a current-status-change corresponding unit 124, to record and manage the characteristic of the module being used or now available and current usage.

The status storage unit 122 stores status information for each item in a provision format for each provision format of each module. By referring to the status information, it can be recognized how the module provides the common format information.

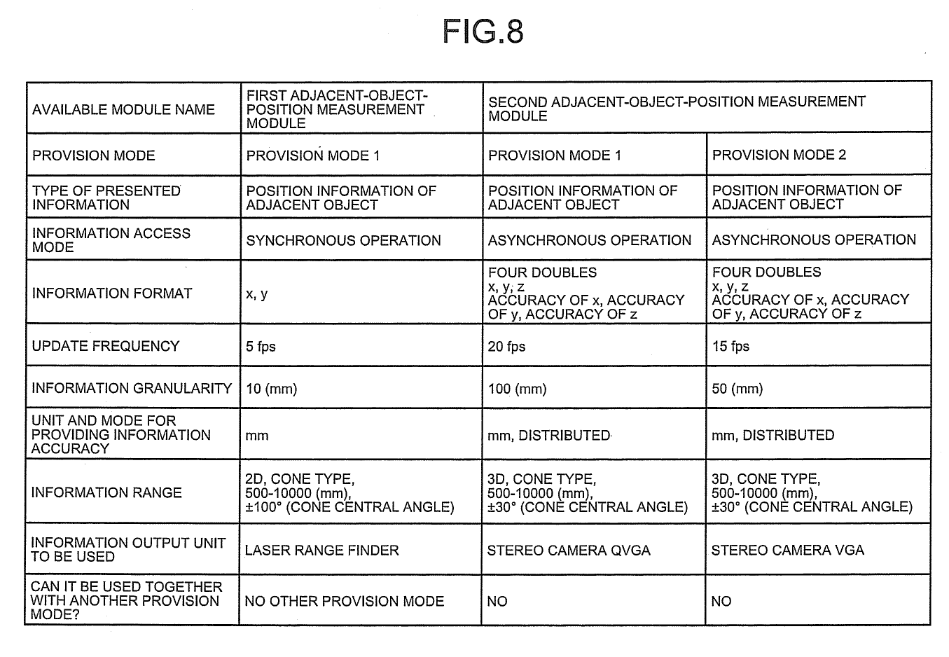

As shown in FIG. 8, records are registered in the status storage unit 122 for each provision format of each module. When each module notifies that there is a characteristic or environmental change in the information device, the status information stored in the status storage unit is also updated.

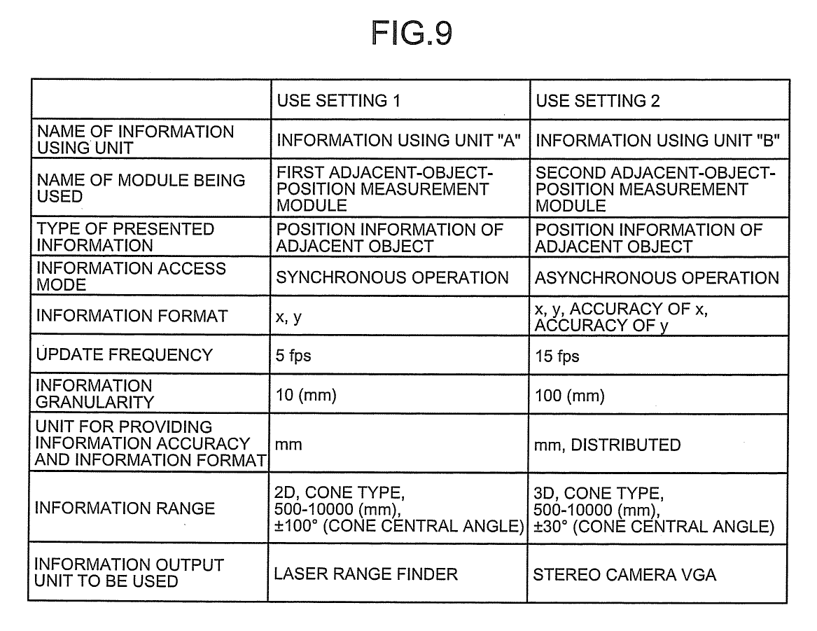

The request-condition storage unit 123 stores a startup condition allocated to each module to satisfy the use request condition from the information using unit. As shown in FIG. 9, the request-condition storage unit 123 stores the startup condition for each module to satisfy the use request, for each use request from the information using unit. Further, the records are registered when the information use request is received from the information using unit, and deleted when the information using unit has finished the use of information.

Upon reception of the information-provision disabling signal from an arbitrary module, the current-status-change corresponding unit 124 transmits the information-provision disabling signal to the solver unit 131. Upon reception of the information-provision enabling signal, the current-status-change corresponding unit 124 transmits an information device change signal. The current-status-change corresponding unit 124 also updates the status storage unit 122 according to the characteristic of the information device input together with these signals.

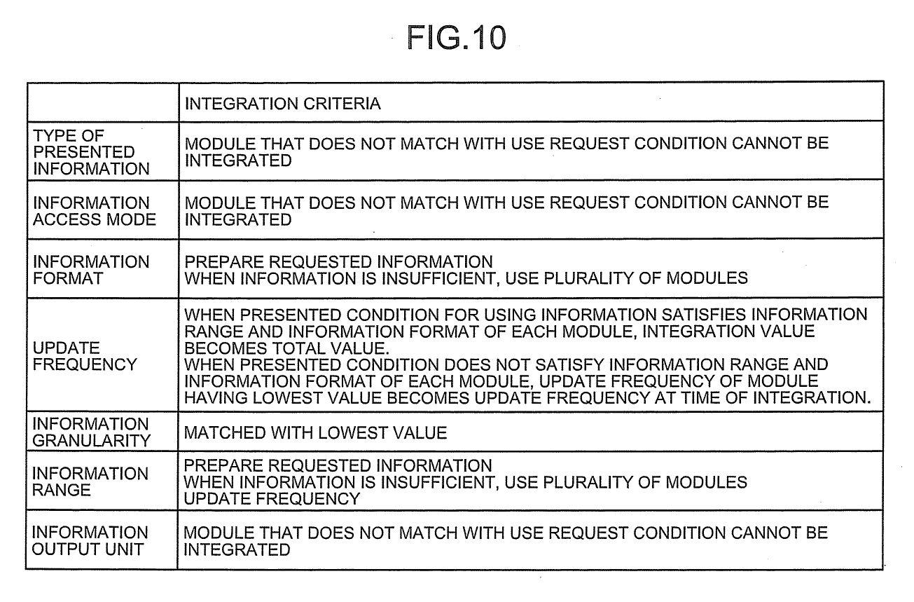

The integration-criteria-information storage unit 125 stores criteria information for integrating pieces of information of the provision format of each module, stored in the status storage unit 122, in order to satisfy the use request condition from the information using unit. As shown in FIG. 10, the integration-criteria-information storage unit 125 holds the criteria information at the time of integration for each item of provision mode. Integration becomes possible when the criteria information for all the items is satisfied.

Returning to FIG. 2, the solver unit 131 includes a specifying unit 132, an acquiring unit 133, a processing unit 134, an input receiving unit 138, and an output unit 135, to provide information in response to a request from each information using unit. The solver unit 131 specifies and controls a module to be used according to the information held in the module storage unit 121 and the use request condition presented by the information using unit, and provides information from the specified module to the information using unit. The information to be provided is referred to as use information.

The input receiving unit 138 receives a request from the information using unit via the API provided by the solver unit 131.

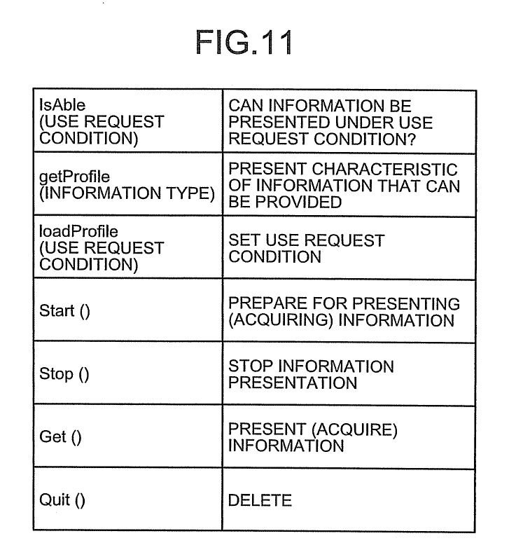

As shown in FIG. 11, the solver unit 131 provides various APIs to the information using units. For example, by invoking IsAble (use request condition), determination whether information can be provided can be requested under the use request condition set by the parameter. When it is determined that information can be provided, loadProfile (use request condition) is invoked, to thereby set the use request condition for acquiring the information. By invoking Start( ), preparation of information provision is requested, and by invoking Get( ), acquisition of the common format information output from the information device is requested. By invoking getProfile( ), the characteristic of the information that can be provided can be presented. In addition, there are Stop( ) for interrupting acquisition of information, and Quit( ) for finishing acquisition of information.

The use request condition is a condition for acquiring the use information, where a condition is set according to need for at least one of respective items of type of presented information, information access mode, information format, update frequency, information fineness, information accuracy, information range, and information device.

The specifying unit 132 compares the use request condition presented for acquiring the information from the information using unit with the characteristic information of the available module stored in the status storage unit 122, to specify a module satisfying the use request condition. At that time, when there is a plurality of modules satisfying the use request condition, the specifying unit 132 specifies a module having the best accuracy as a module to be used for providing the information.

Further, when having determined that there is no module satisfying the condition of request information from the information using unit, the specifying unit 132 extracts a module satisfying the use request conditions of type of presented information, information access mode, information device, and information fineness. The specifying unit 132 selects a plurality of modules from the extracted modules and combines the element of information format and the element of information range, to thereby specify a module group satisfying the use request conditions from the information using unit. When the update frequency of the module group satisfies the update frequency condition included in the use request condition from the information using unit, the specifying unit 132 specifies the module group as a module to be used for providing the use information to the information using unit. In comparison of the update frequency, it is compared with the lowest update frequency of the modules.

Further, when having determined that the update frequency included in the use request condition from the information using unit is not satisfied, the specifying unit 132 combines a plurality of module groups to add the update frequencies, and the added update frequency is compared with the update frequency included in the use request condition. When the update frequency included in the use request condition is satisfied, the specifying unit 132 specifies the module groups as the module group to be used for providing the use information to the information using unit.

The specifying unit 132 then calculates a startup condition for satisfying the use request condition for each module in the module group determined as satisfying the use request condition. The common format information acquired from each module, which is started up under the calculated startup condition, is processed to thereby generate the use information satisfying the use request condition.

The startup condition for acquiring the name of the module specified by the specifying unit 132 and the common format information is registered in the request-condition storage unit 123 in the module storage unit 121, in response to a request from the solver unit 131. When the specified module is being used by another information using unit, and is the same as the use request condition of the other information using unit or included in the use request condition thereof, the module is registered in the request-condition storage unit 123 in the module storage unit 121. The common format information acquired from the module is processed by the processing unit 134 so that the use request conditions of the respective information using units are satisfied.

Further, when the specified module is being used by another information using unit, but is different from the use request condition of the other information using unit, the condition for acquiring the name of the module specified by the specifying unit 132 and the common format information is registered in the request-condition storage unit 123 in the module storage unit 121, and it is requested to the module to change the condition for generating the common format information.

The acquiring unit 133 acquires the common format information from the specified module or module group.

The processing unit 134 includes a generating unit 136 and a copying unit 137, to process the common format information input from each module to the use information matched with the use request condition of the information using unit.

The generating unit 136 combines the common format information input from a plurality of modules. The copying unit 137 copies the common format information input from the module so that it can be used by a plurality of information using units. The combined and copied pieces of common format information are output to the output unit 135 as the use information to be used by the information using units.

The output unit 135 outputs the input use information to the information using unit, which has requested acquisition of the use information.

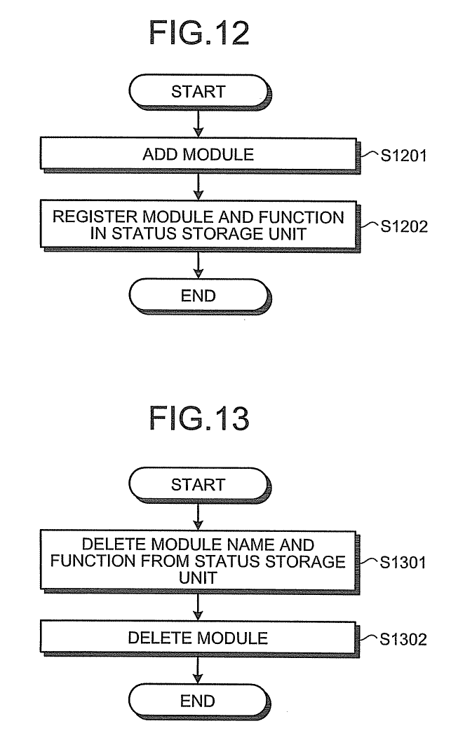

A process procedure when a module is added to the information processing apparatus 200 is explained next with reference to FIG. 12.

First, a module is added to the information reforming module group in the information processing apparatus 200 (step S1201). In the module storage unit 121, the module name of the added module and the function thereof that can be provided are registered in the status storage unit 122 (step S1202). Accordingly, the module can be used in response to a request from the information using unit.

A process procedure when a module is deleted from the information processing apparatus 200 is explained next with reference to FIG. 13.

First, in the module storage unit 121, the module name of the module to be deleted and the function thereof that can be provided are deleted from the status storage unit 122 (step S1301). The module is then deleted from the information reforming module group in the information processing apparatus 200 (step S1302). Accordingly, the module cannot be used in response to the request from the information using unit.

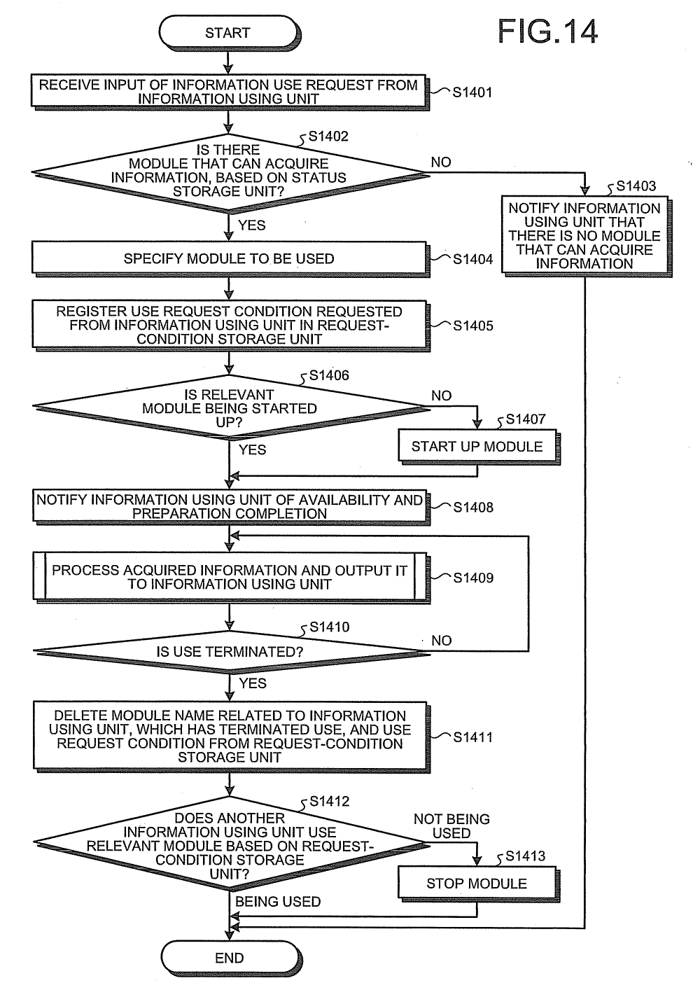

A process procedure when acquisition of information is requested from the information using unit is explained next with reference to FIG. 14.

First, the input receiving unit 138 receives an input of information acquisition request from the information using unit A 141 (step S1401). The input receiving unit 138 also receives an input of the use request condition indicating any one or a plurality of the presented information type, the information access mode (synchronous or asynchronous), the information format, the lowest frequency of update, an expected value of the update frequency, allowable information fineness, an expected value of information fineness, the lowest accuracy of information, an expected value of information accuracy, an effective area of information desired to acquire, and the information device, together with the acquisition request.

Next, the specifying unit 132 determines whether there is a module that satisfies the use request condition (that can acquire information), according to the status of each module (the function that can be currently provided) stored in the status storage unit 122, by referring to the module storage unit 121 (step S1402). Detailed process procedure will be explained later.

When having determined that there is no module satisfying the use request condition (NO at step S1403), the specifying unit 132 notifies the information using unit that there is no available module (step S1403), to finish the process.

When having determined that there is a module satisfying the use request condition (YES at step S1403), the specifying unit 132 specifies the module as a module to be used (step S1404).

The use request condition required for providing the information is then registered with respect to the specified module in the request-condition storage unit 123 in the module storage unit 121 (step S1405).

The acquiring unit 133 then determines whether the module specified as the one satisfying the use request condition from the information using unit is being active (step S1406). When having determined that the module is not active (NO at step S1406), the acquiring unit 133 instructs the module to start up with the registered use request condition (step S1407).

When startup with the use request condition is not possible, a startup disabling signal is transmitted from the module to the acquiring unit 133.

Even if the module is active, the acquiring unit 133 determines whether the current startup condition of the module satisfies the use request condition registered in the request-condition storage unit 123. When having determined that the use request condition registered in the request-condition storage unit 123 is not satisfied, the acquiring unit 133 transmits a change instruction to the module to start up with the startup condition satisfying the registered use request condition.

In the module, initialization of the information device and change of setting are performed so that the module is started up according to the startup condition. When the respective sensors are started up according to the startup condition, the startup-setting storage unit 207 is updated to the startup condition and the setting for operating under the startup condition.

In the module, after the startup-setting storage unit 207 is updated, a startup preparation complete signal is transmitted to the acquiring unit 133 in the solver unit 131.

Upon reception of the startup preparation complete signal, the acquiring unit 133 outputs an availability/preparation completion notification to the information using unit (step S1408).

Upon reception of the availability/preparation complete notification, the information using unit invokes the API of the solver unit 131 to make an information acquisition request. Accordingly, the solver unit 131 processes the common format information input from each module and outputs the processed common format information to the information using unit as the use information (step S1409). A procedure at the time of providing the information to the information using unit will be described later.

The solver unit 131 determines whether a termination indication of the use of information has been received from the information using unit via the API (step S1410). When it is determined that the termination indication has not been received (NO at step S1410), the process from step S1409 is repeated again.

On the other hand, when it is determined that the termination indication has been received (YES at step S1410), the solver unit 131 outputs the name of the information using unit, which has sent the termination indication, and a notification indicating reception of the termination indication to the module storage unit 121.

Accordingly, the module storage unit 121 deletes the module name related to the information using unit and the use request condition from the request-condition storage unit 123 (step S1411).

The module storage unit 121 determines whether another information using unit is using the deleted module based on the request-condition storage unit 123 (step S1412). When having determined that the module is not being used, the module storage unit 121 notifies the solver unit 131 of this fact. The acquiring unit 133 in the solver unit 131 instructs the module, which is determined as not being used, to stop the operation (step S1413).

On the other hand, when having determined that the module is being used, the module storage unit 121 continuously controls the module. However, the startup condition with respect to the module may be changed due to deletion of the module name and the use request condition in the request-condition storage unit 123. In this case, the module storage unit 121 transmits the module name and the startup condition changed due to deletion to the solver unit 131.

When the solver unit 131 receives the changed module name and startup condition, the acquiring unit 133 notifies the module indicated by the module name of the startup condition. Upon reception of the startup condition, the module having received the notification updates the startup condition and setting for controlling the output unit stored in the startup-setting storage unit 207. Thereafter, the module outputs a signal for changing the startup condition and initialization, or a stop signal to the information device according to the updated content.

Upon reception of the signal for the change of the startup condition and initialization or the stop signal, the information device changes the startup condition and performs initialization according to the signal, and then outputs a complete signal to the module. Alternately, upon reception of the stop signal, the information device stops the operation.

Upon reception of the complete signal from the information device, the module transmits a change complete signal to the solver unit 131. When the acquiring unit 133 in the solver unit 131 receives the change complete notification, the output unit 135 transmits a complete signal to the information using unit. Accordingly, provision of the use information to the information using unit has finished.

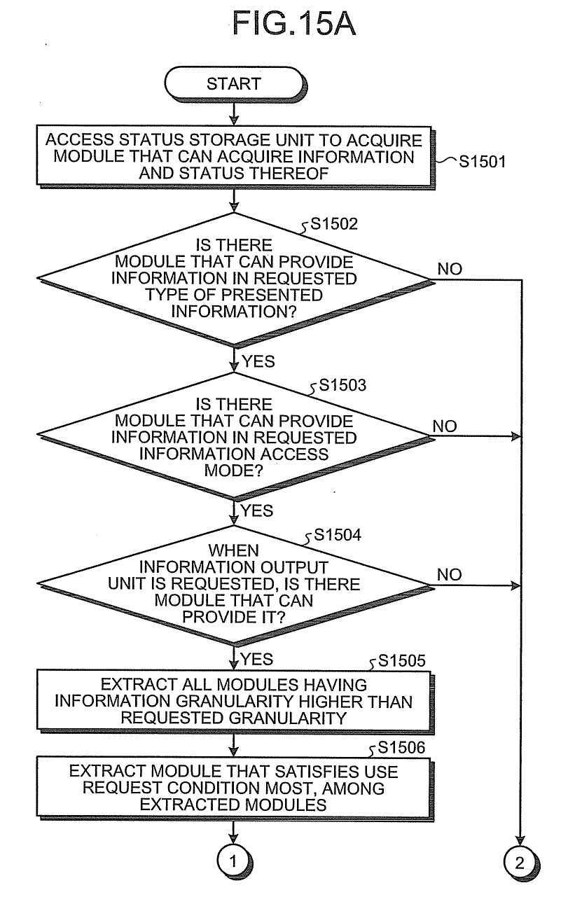

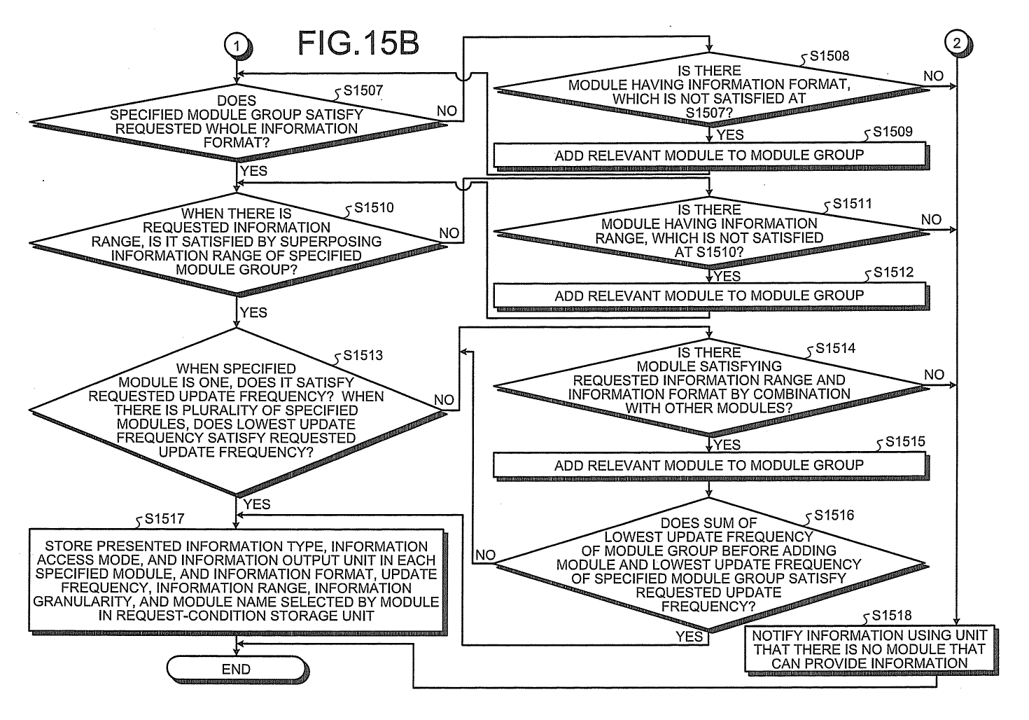

The determination procedure whether there is a module to be used at steps S1402 to S1405 in FIG. 14 is explained next with reference to FIGS. 15A and 15B. The process procedure explained below is an example using the integration criteria shown in FIG. 10.

First, the specifying unit 132 accesses the status storage unit 122 in the module storage unit 121 to acquire the module name of the module that can be used and the status thereof (function that can be currently provided) (step S1501).

Next, the specifying unit 132 then determines whether the presented information type requested as the use request condition from the information using unit matches the presented information type included in the status acquired at step S1501. It is then determined whether there is a module that can provide information in the presented information type according to the determination result above (step S1502). For example, when a match is determined, it is determined that there is a module that can provide the information. At the following steps, when there is a match, it is determined that there is a module that can provide the information.

When having determined that there is a module that can provide information in the presented information type (YES at step S1502), the specifying unit 132 determines whether the information access mode requested as the use request condition from the information using unit matches the information access mode included in the function acquired at step S1501. It is then determined whether there is a module that can provide the information in the information access mode according to whether there is a match (step S1503).

When having determined that there is a module that can provide the information in the information access mode (YES at step S1503), the specifying unit 132 determines whether the information device requested as the use request condition from the information using unit matches the information device included in the function acquired at step S1501. It is then determined whether there is a module that can provide the information by the information device according to whether there is a match (step S1504).

The specifying unit 132 then extracts all the modules, which can provide the information with the information fineness higher than that indicated in the use request condition, among the modules determined that it can provide the information at step S1504 (step S1505).

The specifying unit 132 extracts a module that satisfies the use request condition most, among the extracted modules (step S1506).

The specifying unit 132 then determines whether the specified module group satisfies the whole information format requested in the use request condition (step S1507). When having determined that the whole information format is not satisfied (NO at step S1507), the specifying unit 132 determines whether there is a module that can provide the information in the information format, which is not satisfied at step S1507 (step S1508). When having determined that there is such a module (YES at step S1508), the specifying unit 132 adds the module as the specified module group (step S1509), and then performs again determination at step S1507.

When having determined that the whole information format is satisfied (YES at step S1507), the specifying unit 132 determines whether the information range requested in the use request condition is satisfied by a combination of the information range of the specified module group (step S1510). When having determined that the information range is not satisfied (NO at step S1510), the specifying unit 132 determines whether there is a module having the information range not satisfied at step S1510 (step S1511). When having determined that there is such a module (YES at step S1511), the specifying unit 132 adds the module as the specified module group (step S1512), and then performs again determination at step S1510.

When having determined that all the information range is satisfied at step S1510 (YES at step S1510), and when the specified module is one, the specifying unit 132 determines whether the update frequency of the module satisfies the update frequency included in the use request condition. When there is a plurality of specified modules, the specifying unit 132 determines whether the lowest update frequency of these modules satisfies the update frequency included in the use request condition (step S1513).

When having determined that the update frequency is not specified (NO at step S1513), the specifying unit 132 determines whether there is a module group that satisfies the information range and the information format requested in the use request condition by a combination of other modules extracted at step S1505 (step S1514).

When having determined that there is such a module group (YES at step S1514), the specifying unit 132 adds the module group to the specified module group (step S1515).

The specifying unit 132 then determines whether a result of adding the lowest update frequency of the specified module group and the lowest update frequency of the added module group satisfies the update frequency included in the use request condition (step S1516). When having determined that the update frequency is not satisfied (NO at step S1516), the process from step S1514 is repeated again.

When having determined that the update frequency is satisfied at step S1513 or step S1516, the specifying unit 132 allows the request-condition storage unit 123 to store the condition for the presented information type, the information access mode, and the information device calculated for acquiring the use information for each specified module, and the information format, the update frequency, the information range, the information fineness, and the module name selected by the module (step S1517).

When it is determined to be “NO” at steps S1502, S1503, S1504, S1508, S1511, and S1514, the specifying unit 132 determines that the information cannot be provided to the information using unit, and notifies that there is no module that can provide the information to the information using unit (step S1518).

According to the above process procedure, a module to be used for providing the information to the information using unit is specified. At that time, the information can be provided to the information using unit in a combination of a plurality of modules.

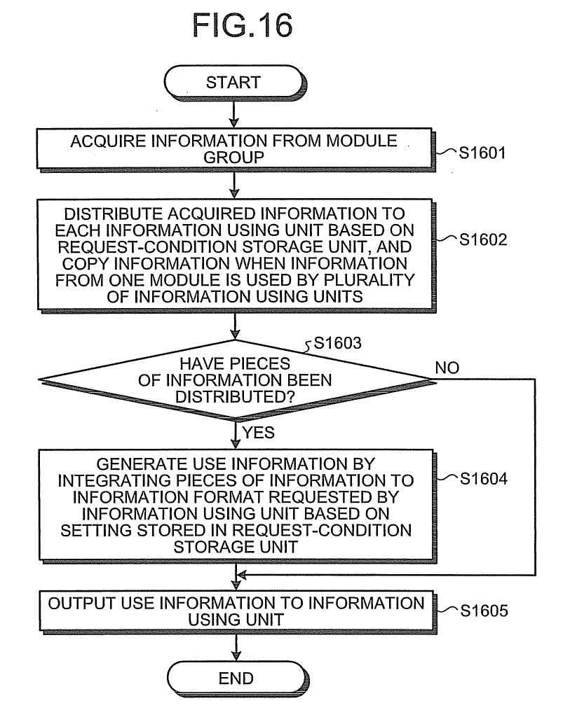

A process procedure from step S1409 at which processing of the common format information is performed until the information is output in FIG. 14 is explained next with reference to FIG. 16.

The acquiring unit 133 in the solver unit 131 acquires the common format information from the specified module or module group (step S1601).

The copying unit 137 distributes the common format information from each module to the information using unit at a destination based on the request-condition storage unit 123. When the common format information output from one module is provided to a plurality of information using units, the copying unit 137 copies the common format information and distributes the information to the information using units, respectively (step S1602).

The generating unit 136 determines whether a plurality of pieces of common format information has been distributed to the information using unit (step S1603). When having determined that the pieces of common format information have not been distributed (NO at step S1603), the generating unit 136 does not perform any process. In this case, the common format information is handled as the use information to be provided to the information using unit.

On the other hand, when having determined that the pieces of common format information have been distributed (YES at step S1603), the generating unit 136 generates the use information by combining the pieces of common format information so that the use request condition is satisfied, based on the integration criteria shown in FIG. 10 (step S1604).

The output unit 135 outputs the use information to the information using unit at the destination (step S1605).

According to the above process procedure, the use information according to the use request condition of each information using unit can be generated from the common format information input to the solver unit 131, and provided.

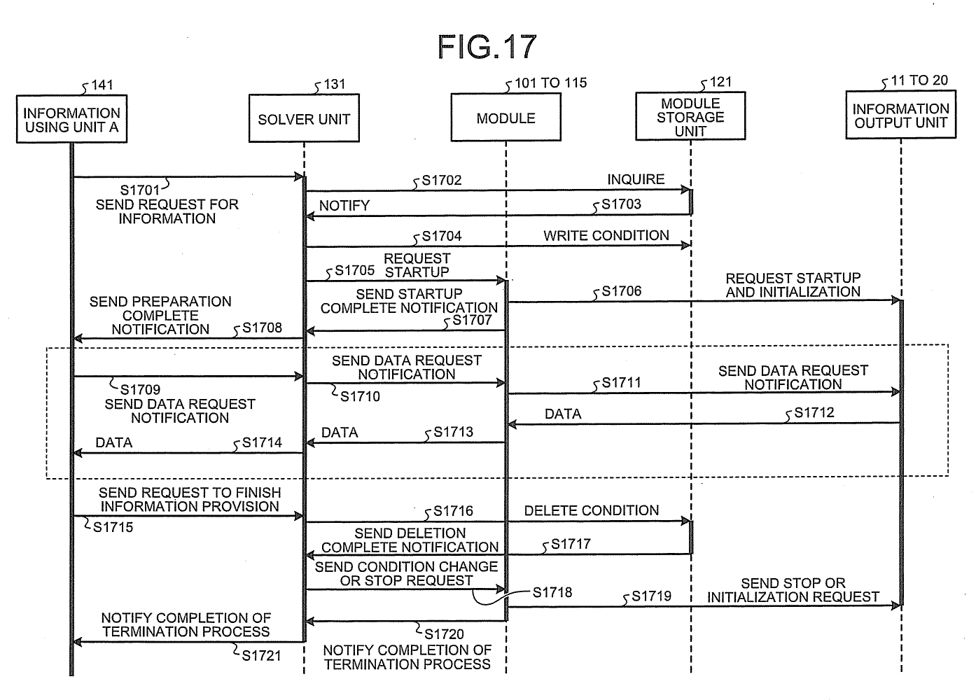

A process procedure for controlling the information devices 11 to 20 when an information provision request is received from the information using unit A 141 is explained next with reference to a timing chart in FIG. 17. In an example shown in FIG. 17, it is assumed that the information access mode included in the use request condition from the information using unit is a synchronous operation.

The information provision request is output from the information using unit A 141 to the solver unit 131 (step S1701). Upon reception of the information provision request, the solver unit 131 refers to the module name and status stored in the status storage unit 122 in the module storage unit 121 (step S1702). The solver unit 131 receives a notification as an inquiry result from the module storage unit 121 (step S1703). Accordingly, the module to be used is specified.

The solver unit 131 registers a condition and the like to use the specified module in the request-condition storage unit 123 (step S1704).

The solver unit 131 then requests startup with respect to the information reforming modules 101 to 115 specified as the module to provide the information (step S1705). The information reforming modules 101 to 115 request startup and initialization with respect to the information devices 11 to 20 connected thereto (step S1706).

Thereafter, the solver unit 131 receives a notification indicating completion of startup of the information devices 11 to 20 from the information reforming modules 101 to 115 (step S1707). Therefore, the solver unit 131 notifies the information using unit A 141 that preparation for providing the information is complete (step S1708).

The information using unit A 141 invokes the API of the solver unit 131 to request data (step S1709). In this case, the solver unit 131 requests the information reforming modules 101 to 115 to acquire data (step S1710). The information reforming modules 101 to 115 makes an acquisition request of data with respect to the information devices 11 to 20 (step S1711).

The information devices 11 to 20 acquire the data based on the set startup condition, upon reception of a data request signal, to thereby output the data to the information reforming modules 101 to 115 (step S1712). After the common format information is generated by abstracting the input information and the like, the information reforming modules 101 to 115 output the common format information to the solver unit 131 (step S1713). The solver unit 131 then processes the common format information to match with the use request condition, and provides the common format information as the use information to the information using unit A 141 (step S1714). The process from steps S1709 to S1714 is repeated while the information using unit A 141 requests provision of the information.

Thereafter, the information using unit A 141 outputs a request to finish information provision to the solver unit 131 (step S1715). Upon reception of the request to finish information provision, the solver unit 131 requests to delete the module name and status stored in the status storage unit 122 in the module storage unit 121 (step S1716). After completion of deletion, the solver unit 131 receives a deletion complete notification from the module storage unit 121 (step S1717).

The solver unit 131 requests a change of the startup condition or stop with respect to the information reforming modules 101 to 115, as a result of completion of information provision to the information using unit A 141 (step S1718). Upon reception of the request, the information reforming modules 101 to 115 request stop or initialization with respect to the information devices 11 to 20 connected thereto (step S1719).

After the information devices 11 to 20 have been stopped or initialized, the information reforming modules 101 to 115 notify the solver unit 131 of completion of a termination process (step S1720). The solver unit 131 then notifies the information using unit A 141 of completion of the termination process (step S1721). Accordingly, information provision to the information using unit A 141 has been complete.

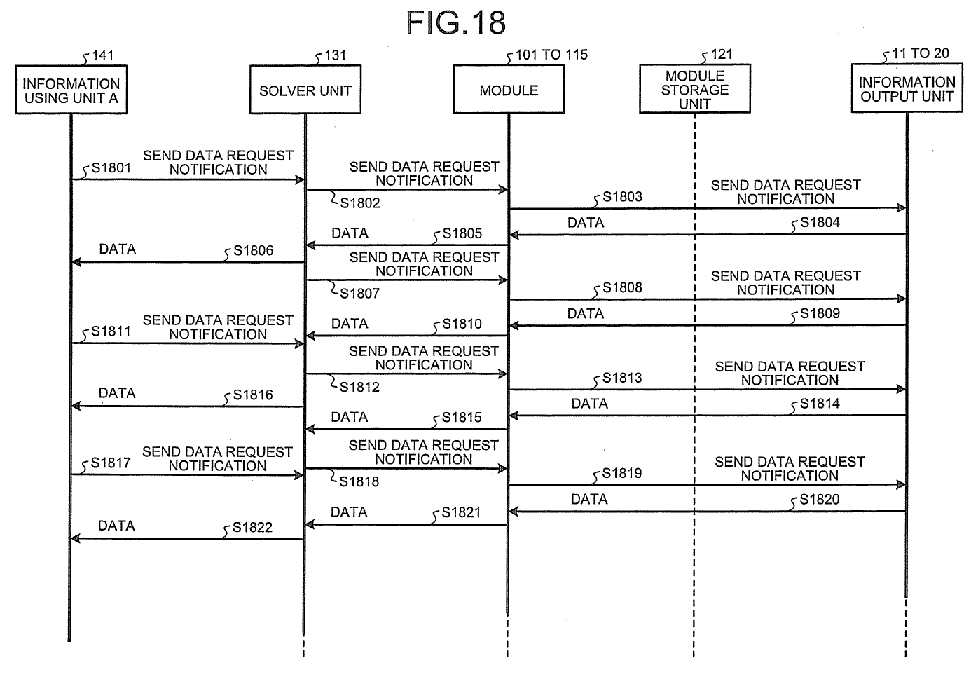

In the timing chart shown in FIG. 17, an example in which the information devices 11 to 20 acquire data synchronously with the request from the information using unit A 141 has been explained. A case that the information access mode included in the use request condition from the information using unit A 141 is an asynchronous operation is explained next with reference to a timing chart in FIG. 18. In the timing chart shown in FIG. 18, steps S1701 to S1708 in FIG. 17 as preprocessing and steps S1715 to S1721 in FIG. 17 as post-processing are performed, and explanations thereof will be omitted.

The solver unit 131 transmits a data request signal to the information reforming modules 101 to 115 to be used for satisfying the use request condition, at a predetermined cycle decided for satisfying the use request condition of a plurality of information using units (steps S1802, S1807, S1812, and S1818). Upon reception of the data request signal, the information reforming modules 101 to 115 transmit the data request signal to the information devices 11 to 20 connected thereto (steps S1803, S1808, S1813, and S1819).

Upon reception of the data request signal, the information devices 11 to 20 acquire the data based on the set startup condition and transmit the data to the information reforming modules 101 to 115 (steps S1804, S1809, S1814, and S1820).

The editing/abstracting unit 204 in the information reforming modules 101 to 115 respectively edits and abstracts the received data and transmits the result to the solver unit (steps S1805, S1810, S1815, and S1821). These processes are repeated with a predetermined cycle.

The information using unit A 141 invokes the API, as required, to request acquisition of data to the solver unit 131 (steps S1801, S1811, and S1817). The solver unit 131 processes the latest common format information input from the module group according to the use request condition of the information using unit A 141, and outputs the processed common format information to the information using unit A 141 (steps S1806, S1816, and S1822).

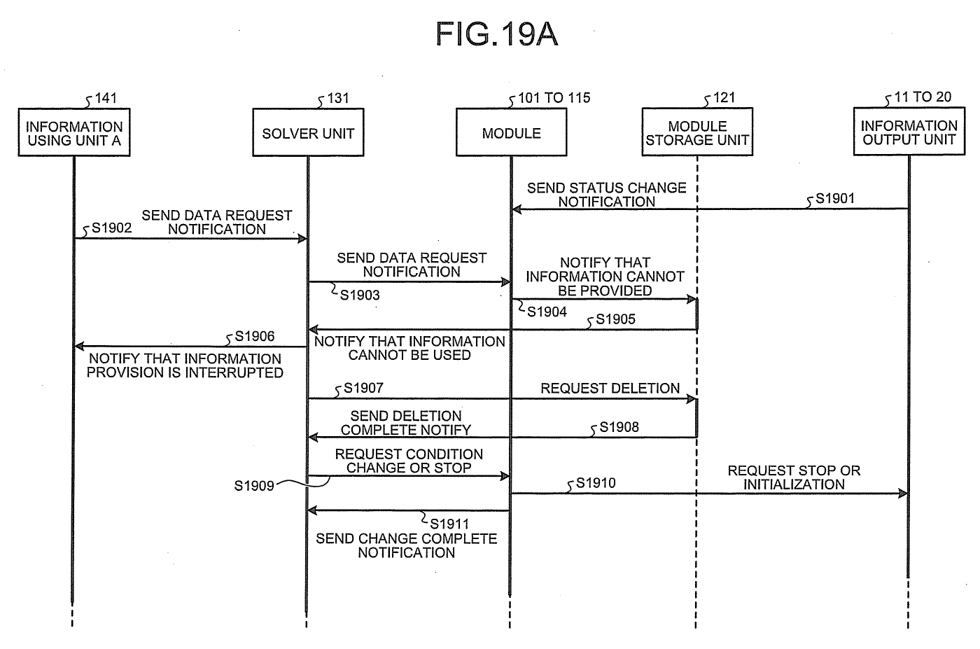

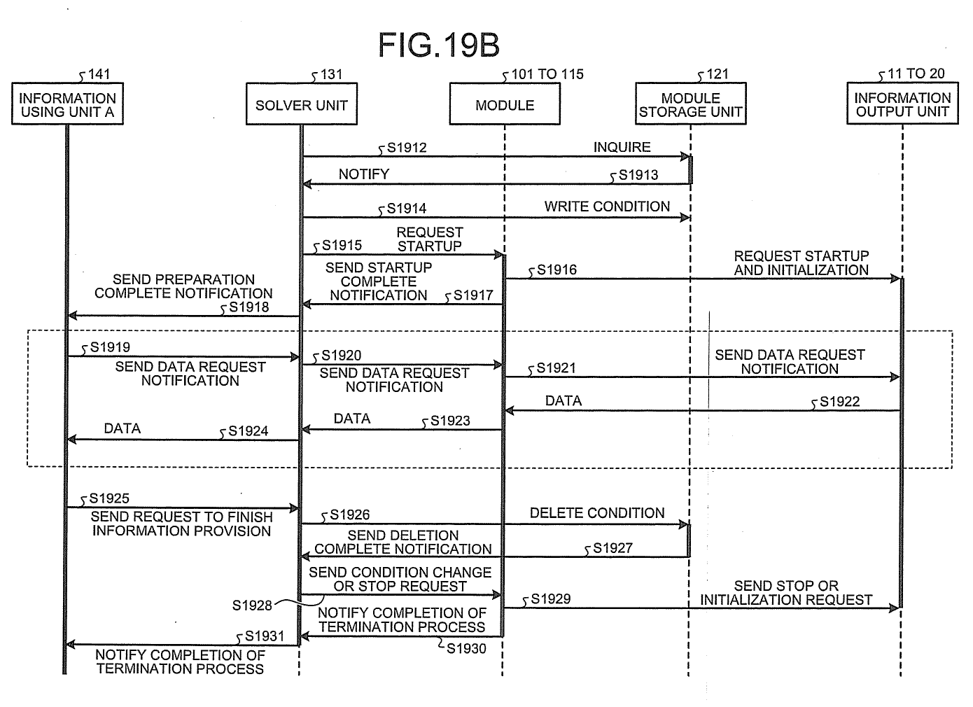

A process procedure when the characteristic or status has changed in the information devices 11 to 20 is explained next with reference to timing charts in FIGS. 19A and 19B.

First, when there is an environmental change due to time course, a change of an installation position of the sensor, or a load change of the connected network as a status change, or the number of faults of the sensor and the number of sensors increases or decreases as a characteristic change, the information devices 11 to 20 notify the information reforming modules 101 to 115 connected thereto that there is a characteristic change or status change as the current status (step S1901).

The characteristic change detecting unit 206 in the information reforming modules 101 to 115 having received the notification receives a notification of the status or characteristic change of the sensor. When the characteristic change detecting unit 206 detects that the status has changed, the module-availability determining unit 208 calculates the characteristic change of the module based on the received notification content, and compares the calculation result with the startup condition stored in the startup-setting storage unit 207. As a result of comparison, when it is determined that the information cannot be provided, the module-availability determining unit 208 transmits the changed characteristic of the module and the information-provision disabling signal to the module storage unit 121 (step S1904).

Although different from the timing chart, as a result of comparison, if it is determined that the information can be provided, the module-availability determining unit 208 transmits the changed characteristic of the module and the information-provision enabling signal to the module storage unit 121. In conjunction with these notifications, the status storage unit 122 in the module storage unit 121 is updated according to the notification content.

Returning to the timing chart in FIG. 19, on the other hand, even if a data acquisition request is made from the information using unit A 141 to the solver unit 131 (step S1902), and the solver unit 131 makes the data request to the information reforming modules 101 to 115 (step S1903), the data acquisition request is interrupted when it is determined that the information cannot be provided.

When the information-provision disabling signal is received, the current-status-change corresponding unit 124 in the module storage unit 121 transmits the information-provision disabling signal to the solver unit 131 (step S1905). Although different from the timing chart, if the current-status-change corresponding unit 124 receives the information-provision enabling signal, the current-status-change corresponding unit 124 transmits the information device change signal to the solver unit 131. In this case, upon reception of the characteristic change signal of the module from the information reforming modules 101 to 115, the current-status-change corresponding unit 124 updates the status storage unit 122 according to the received characteristic change of the module.

Returning to the timing chart, upon reception of the information-provision disabling signal, the acquiring unit 133 in the solver unit 131 notifies the information using unit A 141 that the information provision is being interrupted (step S1906). Further, the acquiring unit 133 outputs a request to delete the started up module and the use request condition to the module storage unit 121 (step S1907).

The current-status-change corresponding unit 124 in the module storage unit 121 deletes the started up module and the startup condition from the request-condition storage unit 123 according to the deletion request. The current-status-change corresponding unit 124 then transmits the module name and the startup condition changed as a result of deletion to the solver unit 131, together with a deletion complete notification (step S1908).

Upon reception of the module name and the startup condition changed as a result of deletion and the deletion complete notification, the acquiring unit 133 in the solver unit 131 notifies each module of the startup condition to be changed. Further, the acquiring unit 133 transmits a stop request to a module, which is not to be used (step S1909).

Upon reception of the startup condition change notification or stop notification, the startup-setting storage unit 207 in the information reforming modules 101 to 115 transmit the signal for changing the startup condition and initialization, or the stop signal to the information device, whose startup condition has been changed, among the information devices connected thereto (step S1910). Accordingly, upon reception of the signal for the change of startup condition and initialization, the information devices 11 to 20 change the startup condition or initialize, and transmit a complete signal to the module. Alternatively, upon reception of the stop signal, the information devices 11 to 20 stop the operation.

Upon reception of the complete signal from the information devices 11 to 20, the information reforming modules 101 to 115 transmit a change complete signal to the solver unit 131 (step S1911). Accordingly, the process involved with the status change or characteristic change is complete. When having received the complete signal, the solver unit 131 performs processing from step S1401 in FIG. 14.

That is, the specifying unit 132 in the solver unit 131 determines whether there is a module satisfying the use request condition based on the function of each module stored in the status storage unit 122, by referring to the module storage unit 121 (step S1912). The specifying unit 132 then receives a notification of the information stored in the status storage unit 122 from the module storage unit 121 (step S1913).

Accordingly, when having determined that there is a module satisfying the use request condition, the specifying unit 132 in the solver unit 131 specifies the module as a module to be used. In response to an instruction from the specifying unit 132, the startup condition required for providing the information with respect to the specified module is registered in the request-condition storage unit 123 in the module storage unit 121 (step S1914).

Thereafter, the module is started up as in the process at from steps S1705 to S1721 in FIG. 17, to provide the use information to the information using unit A 141, to thereby finish provision of the use information (steps S1915 to S1931).

According to the above process procedure, when the characteristic or the status of the information devices 11 to 20 changes, if there are other information devices 11 to 20 that can provide the information, switching is automatically performed to use the other information devices 11 to 20. Accordingly, even if there is a change, the use information can be appropriately provided to the information using unit. Therefore, the information using unit needs not install a program or the like, taking a characteristic change into consideration.

In the information processing apparatus 200, plug-and-play of the information device is enabled according to a space change or time change.

Furthermore, in the information processing apparatus 200, initialization and the startup condition can be dynamically changed with respect to the information device, in conjunction with a start request and a termination request of information provision from the information using unit.

Further, in the information processing apparatus 200, because the processing unit 134 in the solver unit 131 processes the information, appropriate information can be provided to the information using unit. Furthermore, because the use information obtained by combining the common format information or copying the common format information can be provided, flexible information provision becomes possible.

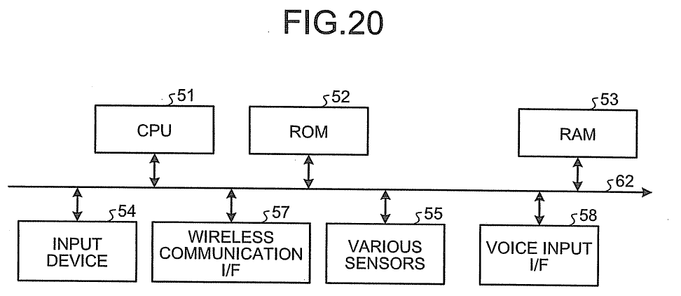

As shown in FIG. 20, the information processing apparatus 200 according to the present embodiment includes, as a hardware configuration, a read only memory (ROM) 52 in which the information processing program for performing the processing described above is stored, a central processing unit (CPU) 51 that controls respective units in the information processing apparatus 200 according to the program in the ROM 52, a random access memory (RAM) 53 as a data storage area, a wireless communication interface (I/F) 57 for connecting to a wireless network to perform communication, an input device 54, various sensors 55, a voice input I/F 58, and a bus 62 to connect the respective units.

The information processing program can be recorded on a computer-readable recording medium such as a compact disk (CD)-ROM, a Floppy® disk (FD), and a digital versatile disk (DVD) in an installable format or executable format, and provided.

In this case, the information processing program is read from the recording medium and executed on the information processing apparatus 200, to load the program on the RAM 53, so that the respective units explained in the software configuration are generated on the RAM 53.

The information processing program executed according to the above embodiment can be stored on a computer that is connected to a network such as the Internet, downloaded through the network, and provided.

While an embodiment of the present invention has been explained above, various modifications and improvements can be added to the embodiment.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing apparatus comprising:
a plurality of information reforming modules that reform input information input from each information device to common format information, which is a format common to the respective information devices;
a status-information storage unit that stores status information indicating a status for each of predetermined items of the common format information reformed by the information reforming modules, for each of the information reforming modules;
an input receiving unit that receives an input of a use request condition including a condition for each of the predetermined items;
a specifying unit that specifies the information reforming module that satisfies the use request condition, from one or a combination of a plurality of pieces of status information stored in the status-information storage unit;
an acquiring unit that acquires the common format information reformed by the specified information reforming module;
a processing unit that processes the common format information to use information matched with the use request condition; and
an output unit that outputs the use information.

2. The apparatus according to claim 1, wherein the acquiring unit acquires the pieces of common format information from the information reforming modules, and
the processing unit includes a generating unit that generates the use information matched with the use request condition by combining the acquired pieces of common format information.

3. The apparatus according to claim 1, wherein the input receiving unit receives an input of a plurality of use request conditions, and
the processing unit includes a copying unit that copies the acquired pieces of common format information so that the common format information matches with each of the input use request conditions, to generate the use information.

4. The apparatus according to claim 1, wherein the information reforming module includes
a startup storage unit that stores a startup condition of the information device,
a characteristic detecting unit that detects a characteristic change of the information device, and
an availability determining unit that determines whether the information device can be started up by satisfying the startup condition, when the characteristic change of the information device is detected.

5. The apparatus according to claim 4, wherein a condition is set as the startup condition for at least one of fineness, update frequency, and information range that can be presented, of the input information output by the information device.

6. The apparatus according to claim 1, wherein the information reforming module is at least one of a module that specifies a present position of the own device, a module that detects a moving body, a module that measures a position of an adjacent object, a command input module, a module that detects a contact, a module that detects time, and a module that detects an inclination of the own device, based on the input information input from the respective information devices.

7. The apparatus according to claim 1, wherein the respective information devices that input the input information to be reformed by the information reforming module are at least one of other-information processing apparatuses, a camera sensor, an ultrasonic sensor, a laser range finder, a voice recognition engine, a GUI input engine, a bumper switch, a board timer, an inclination sensor, and an environmental camera.

8. An information processing method comprising:
reforming input information input from each information device to common format information, which is a format common to the respective information devices, by an information reforming module;
storing status information indicating a status for each of predetermined items of the reformed common format information for each of the information reforming modules, in a status-information storage unit;
receiving an input of a use request condition including a condition for each of the predetermined items;
specifying the information reforming module that satisfies the use request condition, from one or a combination of a plurality of pieces of status information stored in the status-information storage unit;
acquiring the common format information reformed by the specified information reforming module;
processing the acquired common format information to use information matched with the use request condition; and
outputting the processed use information.

9. The method according to claim 8, wherein the pieces of common format information are acquired from the information reforming modules in the acquiring, and
the processing includes a generating that generates the use information matched with the use request condition by combining the acquired pieces of common format information.

10. The method according to claim 8, wherein an input of a plurality of use request conditions are received in the receiving, and
the processing includes a copying that copies the acquired pieces of common format information so that the common format information matches with each of the input use request conditions, to generate the use information.

11. The method according to claim 8, wherein
the information reforming module includes a startup storage unit that stores a startup condition of the information device, and
the method further comprising:
detecting a characteristic change of the information device, and
determining whether the information device can be started up by satisfying the startup condition, when the characteristic change of the information device is detected.

12. The method according to claim 11, wherein a condition is set as the startup condition for at least one of fineness, update frequency, and information range that can be presented, of the input information output by the information device.

13. A computer program product having a computer readable medium including programmed instructions for processing information, wherein the instructions, when executed by a computer, cause the computer to perform:
reforming input information input from each information device to common format information, which is a format common to the respective information devices, by an information reforming module;
storing status information indicating a status for each of predetermined items of the reformed common format information for each of the information reforming modules, in a status-information storage unit;
receiving an input of a use request condition including a condition for each of the predetermined items;
specifying the information reforming module that satisfies the use request condition, from one or a combination of a plurality of pieces of status information stored in the status-information storage unit;
acquiring the common format information reformed by the specified information reforming module;
processing the acquired common format information to use information matched with the use request condition; and
outputting the processed use information.

14. The computer program product according to claim 13, wherein the pieces of common format information are acquired from the information reforming modules in the acquiring, and
the processing includes a generating that generates the use information matched with the use request condition by combining the acquired pieces of common format information.

15. The computer program product according to claim 13, wherein an input of a plurality of use request conditions are received in the receiving, and
the processing includes a copying that copies the acquired pieces of common format information so that the common format information matches with each of the input use request conditions, to generate the use information.

16. The computer program product according to claim 13, wherein
the information reforming module includes a startup storage unit that stores a startup condition of the information device, and
the instructions cause the computer to further perform:
detecting a characteristic change of the information device, and
determining whether the information device can be started up by satisfying the startup condition, when the characteristic change of the information device is detected.

17. The computer program product according to claim 16, wherein a condition is set as the startup condition for at least one of fineness, update frequency, and information range that can be presented, of the input information output by the information device.
